(19) United States
(12) Patent Application Publication
(10) Pub. No.: US 2005/0182873 A1
(43) Pub. Date: Aug. 18, 2005

(54) Compound CD-ROM drive

(76) Inventors: Chao-Liang Wang, Hsinchu City (TW); Yung-Hua Su, Bade City (TW)

Correspondence Address: SUPREME PATENT SERVICES, POST OFFICE BOX 2339, SARATOGA, CA, 95070, US

(21) Appl. No.: 10/779,191

(22) Filed: Feb. 14, 2004

(51) Int. Cl. G06F 13/38

(52) U.S. Cl. 710/74

(57) ABSTRACT

A compound CD-ROM drive includes an optical device, a media output/input device and a hard drive received in a case which has an output port and an electrical power connection port so that the optical device, the media output/input device, the hard drive and a power supply are connected to a computer.

### FIELD OF THE INVENTION

The present invention relates to a compound CD-ROM drive that accommodates an optical device, a media output/input device and a hard drive. The CD-ROM drive can be connected to the computer externally or internally.

### BACKGROUND OF THE INVENTION

A conventional CD-ROM device is used to read the data from a compact disc or to write data to a compact disc. Generally, the CD-ROM drive can be connected to the computer externally or internally. The CD-ROM drive is connected in the case of the computer or connected to the computer by an external connector such as USB interface. The conventional CD-ROM drive usually includes only one function. Due to the frequent use of different types of digital appliance, such as digital cameras, personal digital assistants (PDAs) and lap-top computers, memory cards, such as SMSmart Media cards, SD cards, CFCompact Flash card, PCPersonal Computer Memery Cards, International Association Cards, MMCMulti-Media Cards, and MSMemory Stick cards are commonly required to be connected to the computers. Nevertheless, these cards are not a standard requirement for a lap-top computers or personal computers and the conventional CD-ROM drives do not equipped with these functions. Portable hard drives and the cooperation with CD-ROM Drives are popular because the tendency of high volume data requirement. There is, however, no CD-ROM Drive that includes the functions of the memory cards and hard drives.

Therefore, it is desired to have an improved CD-ROM Drive which resolves one or more than one conventional problems mentioned above.

### SUMMARY OF THE INVENTION

In accordance with an aspect of the present invention, there is provided a compound CD-ROM drive that comprises a case, an optical device, a media output/input device and a hard drive. The optical device, the media output/input device and the hard drive are received in a case which has an output port and an electrical power connection port so that the optical device, the media output/input device, the hard drive and a power supply are adapted to be connected to a computer.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a perspective view of a first embodiment of the present invention;

FIG. 2 is an exploded view of the first embodiment of the present invention arranged in an up-side-down fashion;

FIG. 3 is a perspective view of a second embodiment of the present invention, and

FIG. 4 is an exploded view of the second embodiment of the present invention.

### DETAILED DESCRIPTION OF THE PREFERRED EMBODIMENT

The present invention combines an optical device, a media output/input device and a hard drive in a case and includes two main arrangements, which will be described hereinafter.

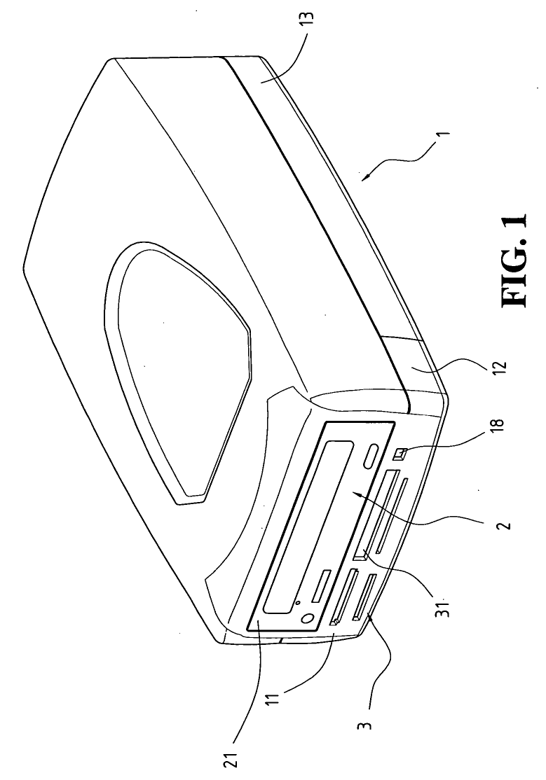

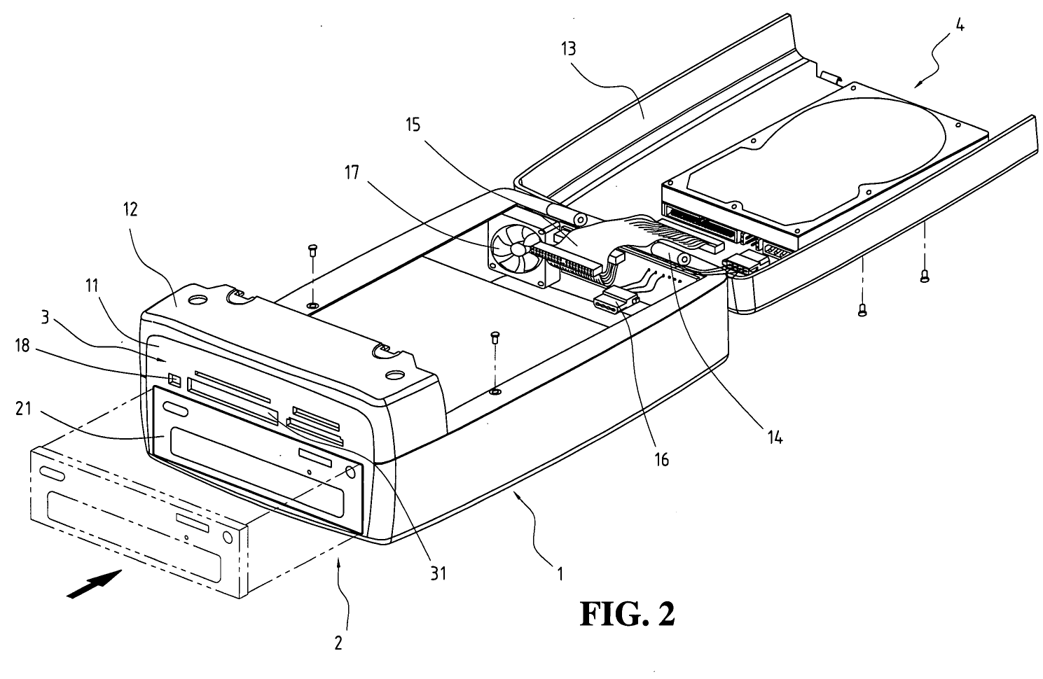

Referring to FIGS. 1 and 2 which show a first preferred embodiment of a compound CD-ROM Drive in accordance with the present invention, comprising a case 1, an optical device 2, a media output/input device 3, and a hard drive 4. The optical device 2 is located in an upper portion of the case 1 and the hard drive 4 is located in the lower portion of the case 1.

FIG. 2 shows an exploded view of the CD-ROM Drive that is positioned up side down. The orientation in the specification is based on the display of FIG. 2. The case 1 is a hollow case and includes a panel 11 on the front side thereof. A plurality of openings is defined through the panel 11. A front cover 12 and a rear cover 13 are formed at the top of the front end and a rear end. The rear cover 13 is pivotably connected of the rear end of the top of the case 1 by a pivotal shaft 14 so that the rear cover 13 can be opened about the pivotal shaft 14 to expose the interior of the case 1.

The optical device 2 includes a read/write CD-ROM drive that is received in the lower portion of the panel 11 of the case 1 so that the optical device 2 can be directly inserted in the panel 11 and arranged in the lower portion of the case 1. The optical device 2 has an operation panel 21 that is accessible from the opening of the panel.

The media output/input device 3 is a memory card input/output device and includes SMSmart Media cards, SD cards, CFCompact Flash card, PCPersonal Computer Memery Cards, International Association Cards, MMCMulti-Media Cards, and MSMemory Stick cards. The media output/input device 3 is located in the front tend of the case 1 and covered by the front cover 12. The panel 11 includes several reading slots 31 on an upper portion thereof and the number of the slots 31 is set according to the specification of the variety of memory cards of the media output/input device.

The hard drive is a memory device and secured to an inside of the rear cover 13 of the case 1. When the rear cover 13 is opened, the hard drive 4 is removed from the interior of the case 1 together of the opening of the rear cover 13.

The front edge of the rear cover 13 and the rear edge of the front cover 12 form a snap device so that when the rear cover 13 is in its close position, the front edge of the front cover 12 is snapped on the rear edge. The rear cover 13 can be opened by unlocking the snap device, the rear cover 13 is disengaged from the rear edge of the front cover 12.

The case 1 has several output ports 15, electrical power connection ports 16 and a fan device 17 connected to the rear end thereof, wherein the output ports 15 are connected to the optical device 2, media output/input device 3 and the hard drive 4 respectively, and in turn, connected to a host port such that the computer is connected to these devices. The electric power connection ports 16 are connected to the optical device 2, the media output/input device 3 and the hard drive 4, and in turn, connected to the host port of the computer so that the electrical power can power the devices. The fan device 17 dispenses heat from the case 1.

In addition, the output ports 15 and the electrical power connection ports 16 can be combined as a USB device or an external port of another specification. Therefore, the compound CD-ROM Drive of the invention can be an external storage device.

The device composed of the output ports 15 and the electrical power connection ports 16 may have the USB and IEEE 1394 interface and at least one socket 18 is extended from the device and connected to the panel 11 of the case 1 so as to provide the external device having the interfaces of USB and IEEE 1394, such as digital cameras, PDAs, recording pens, printers, and scanners.

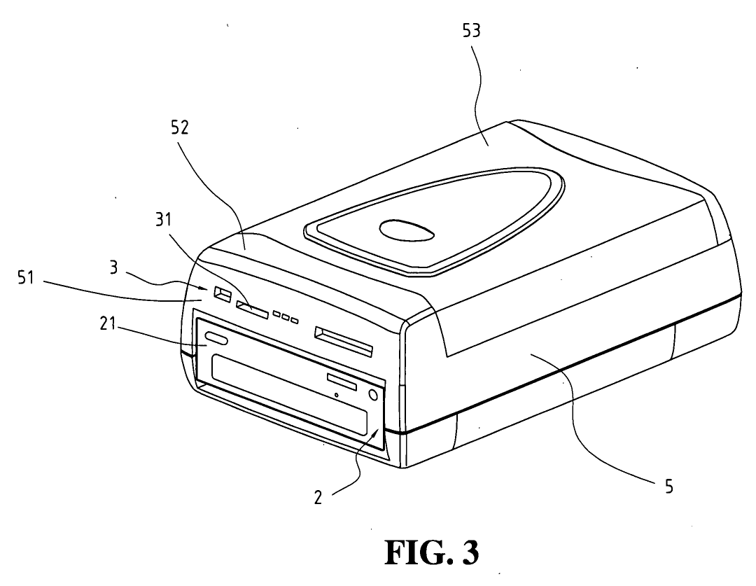

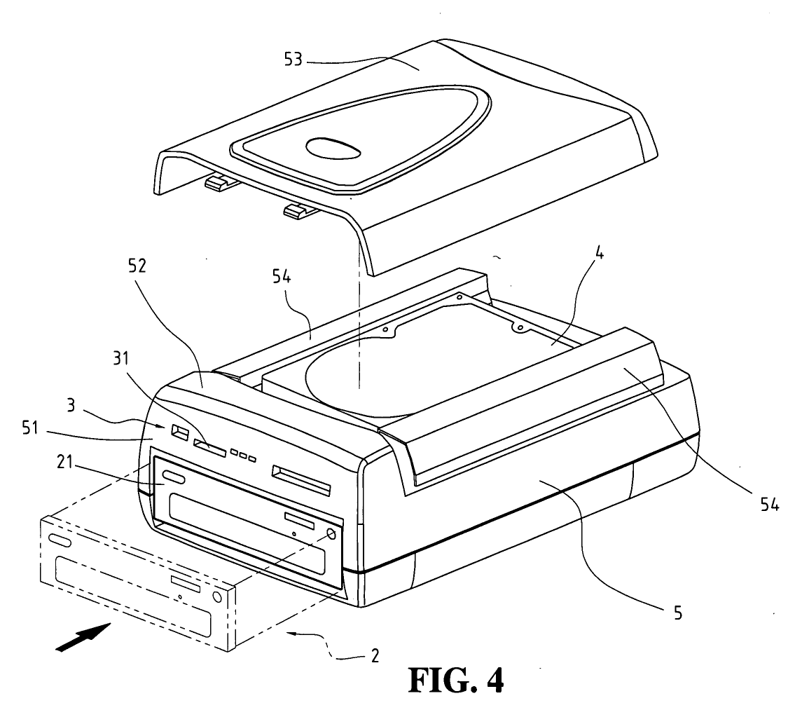

FIGS. 3 and 4 are the perspective view and the exploded view of the other embodiment of the present invention, which comprises a case 5, an optical device 2, a media output/input device 3 and a hard drive 4. The difference is that the hard drive 4 is located at an upper portion of the case 5 and the optical device 4 is located at the lower portion of the case 5.

As shown in FIG. 4, the case 5 has a panel 51 at a front end thereof and the front end and the rear end of the top of the case 5 respectively has a front top cover 52 and a rear top cover 53. The rear top cover 53 can be disengaged from the case 5 and a metal frame 54 is connected to two sides of the interior of the case 5. The hard drive 4 is fixed to the frames 54 and located at the upper portion in the case 1. The metal frames 54 are preferably made of Aluminum, which is benefit for dispensing heat from the hard drive 4. A lock device is located between the rear top cover 53 and the case 1 such that the users may remove the rear top cover 53 from the case 1 in order to install or disengage the hard drive 4.

The optical device 2 is directly installed to the opening of the panel of the case 1 and located in the lower portion of the case 1. The operation panel of the optical device is accessible from the panel of the case. The media output/input device 3 is located in the interior covered by the front top cover 52 of the case 1. The slots 31 of the media output/input device 1 is accessible from the opening at the upper portion of the panel.

The several output ports, the electrical power connection ports and the fan device optical device are similar to the embodiment in FIG. 1 and are installed at the rear end of the case 5.

The compound CD-ROM Drive of the present invention has the optical device, the media output/input device and the hard drive received in the case 1 such that the users are convenient to store and use. The manufacturers may also install the optical device 2 in the upper portion or the lower portion of the case 1 as shown in FIGS. 1 and 3. A rear cover 13 or a rear top cover 53 is equipped with the case such that the user is convenient to install or disengage the hard drive 4 or to check the parts in the case.

While we have shown and described the embodiment in accordance with the present invention, it should be clear to those skilled in the art that further embodiments may be made without departing from the scope of the present invention.

1. A compound CD-ROM drive comprising a case, an optical device, a media output/input device and a hard drive, the optical device, the media output/input device and the hard drive being received in a case which has an output port and an electrical power connection port so that the optical device, the media output/input device, the hard drive and a power supply are adapted to be connected to a computer.

2. The CD-ROM drive as claimed in claim 1, wherein output/input ports and the electrical power connection ports of the case are combined as a USB device or external port of different specification.

3. A compound CD-ROM drive comprising a case, an optical device, a media output/input device and a hard drive, the case having a panel on the front end thereof, a front cover and a rear cover respectively connected to a front end and a rear end of a lower portion of the case, the casing having an output port and an electrical power connection port so that the optical device, the media output/input device, the hard drive and a power supply are adapted to be connected to a computer; the optical device directly installed in an opening in the panel of the case and located in an upper portion of the case, an operation panel of the optical device being accessible from the panel of the case; the media output/input device installed in the interior covered by the front cover of the case, reading slots of the media output/input device being exposed from an opening in the upper portion of the panel of the case, and the hard drive being received in the case and fixed to the lower portion of the case.

4. The CD-ROM drive as claimed in claim 3, wherein the rear cover is connected to an underside of the case.

5. The CD-ROM drive as claimed in claim 3, wherein output/input ports and the electrical power connection ports are combined as a USB device or external port of different specification.

6. The CD-ROM drive as claimed in claim 3, wherein the output ports and the electrical power connection ports are combined as a USB connector, IEEE 1394 connector or external ports of different specification, the connector having at least one socket connected to the panel.

7. A compound CD-ROM drive comprising a case, an optical device, a media output/input device and a hard drive, the case having a panel on the front end thereof, a front top cover and a rear top cover respectively connected to a front end and a rear end of a top of the case, the rear top cover being disengageably connected to the case, the casing having an output port and an electrical power connection port so as to connect to the optical device, the media output/input device, and the hard drive; the optical device directly installed in an opening in the panel of the case and located in a lower portion of the case, an operation panel of the optical device being accessible from the panel of the case; the media output/input device installed in the interior covered by the front top cover of the case, reading slots of the media output/input device being exposed from an opening in upper portion of the panel of the case, and the hard drive being received in the case and fixed to an upper portion of the case.

8. The CD-ROM drive as claimed in claim 7, wherein the rear top cover is connected to the top of the case.

9. The CD-ROM drive as claimed in claim 7, wherein output/input ports and the electrical power connection ports are combined as a USB device or external port of different specification.

10. The CD-ROM drive as claimed in claim 7, wherein the output ports and the electrical power connection ports are combined as a USB connector, IEEE 1394 connector or external ports of different specification, the connector having at least one socket connected to the panel.
